(19) United States
(12) Patent Application Publication
(10) Pub. No.: US 2023/0137355 A1
(43) Pub. Date: May 4, 2023

(54) METHODS AND APPARATUS FOR MANUFACTURING A GLASS RIBBON

(71) Applicant: Corning Incorporated, Corning, NY (US)

(72) Inventors: Douglas Dale Bressler, Julian, PA (US); Matthew John Cempa, Tyrone, PA (US); Francisco Javier Moraga, Corning, NY (US); Shyam Prasad Mudiraj, Valley Cottage, NY (US)

(21) Appl. No.: 17/907,736

(22) PCT Filed: Apr. 26, 2021
(86) PCT No.: PCT/US2021/029060

§ 371 Date: Sep. 29, 2022

Related U.S. Application Data
(60) Provisional application No. 63/019,540, filed on May 4, 2020.

(51) Int. Cl. C03B 17/06

(52) U.S. Cl. CPC C03B 17/067; C03B 17/064

(57) ABSTRACT

A glass manufacturing apparatus includes a forming apparatus defining a travel path extending in a travel direction. The forming apparatus conveys a ribbon of glass-forming material along the travel path in the travel direction. The glass manufacturing apparatus includes a cooling tube including a first end and a second end. The cooling tube includes a first tube including a closed first sidewall surrounding a first channel. The first tube receives a first cooling fluid within the first channel. The cooling tube includes a second tube including a closed second sidewall surrounding a second channel. The first tube is positioned within the second tube. The second tube receives a second cooling fluid within the second channel. The cooling tube includes a nozzle. The nozzle receives the first cooling fluid and directs the first cooling fluid toward the travel path. Methods include manufacturing a glass ribbon with the glass manufacturing apparatus.

### CROSS-REFERENCE TO RELATED APPLICATIONS

This application claims the benefit of priority under 35 U.S.C. § 119 of U.S. Provisional Application Ser. No. 63/019,540 filed on May 4, 2020, the content of which is relied upon and incorporated herein by reference in its entirety.

### FIELD

The present disclosure relates generally to methods for manufacturing a glass ribbon and, more particularly, to methods for manufacturing a glass ribbon with a glass manufacturing apparatus comprising a cooling tube.

### BACKGROUND

Glass ribbons are commonly used, for example, in display applications, such as, liquid crystal displays (LCDs), electrophoretic displays (EPDs), organic light emitting diode displays (OLEDs), plasma display panels (PDPs), touch sensors, photovoltaics, or the like. Such displays can be incorporated, for example, into mobile phones, tablets, laptops, watches, wearables and/or touch capable monitors or displays. Glass ribbons are commonly fabricated by flowing molten glass to a forming body whereby a glass web may be formed by a variety of ribbon forming processes, for example, slot draw, float, down-draw, fusion down-draw, rolling, tube drawing, or up-draw. The glass ribbon may be periodically separated into individual glass ribbons. The thickness of a ribbon of glass-forming material can be controlled before the ribbon of glass-forming material cools into a glass ribbon. However, there is a need for methods of manufacturing a glass ribbon that can more effectively and quickly cool a ribbon of glass-forming material.

### SUMMARY

The following presents a simplified summary of the disclosure to provide a basic understanding of some embodiments described in the detailed description.

In some embodiments, a glass manufacturing apparatus can comprise a cooling tube comprising a first tube positioned within a second tube. A first cooling fluid can flow through the first tube and may exit the first tube toward a ribbon of glass-forming material. In some embodiments, a portion of the first cooling fluid may undergo a phase change from a solid or liquid to a gas within the first tube. In addition, or in the alternative, in some embodiments, upon exiting the first tube, another portion of the first cooling fluid may undergo a phase change from a solid or liquid to a gas. The phase change can cause a reduction in temperature of the ribbon of glass-forming material. Due to the elevated temperature (e.g., within a range from about 400° Celsius (“C”) to about 1000° C.) that the cooling tube is exposed to, and to limit the phase change from occurring within the first tube and prior to the first cooling fluid's exit from the first tube as a result of the elevated temperature, a second cooling fluid can flow through the second tube. The second cooling fluid can impinge upon the first tube. The second cooling fluid can be maintained at a temperature that is lower than a temperature of a surrounding environment. As such, the second cooling fluid can thermally shield the first tube from the surrounding environment and, thus, control a location at which the first cooling fluid undergoes the phase change.

In accordance with some embodiments, a glass manufacturing apparatus can comprise a forming apparatus defining a travel path extending in a travel direction. The forming apparatus can convey a ribbon of glass-forming material along the travel path in the travel direction. The glass manufacturing apparatus can comprise a cooling tube comprising a first end and a second end opposite the first end. The second end can be positioned adjacent to the travel path. The cooling tube can comprise a first tube comprising a closed first sidewall surrounding a first channel. The first tube can receive a first cooling fluid within the first channel. The cooling tube can comprise a second tube comprising a closed second sidewall surrounding a second channel. The first tube can be positioned within the second tube such that the second channel may be between the closed first sidewall and the closed second sidewall. The second tube can receive a second cooling fluid within the second channel. The cooling tube can comprise a nozzle attached to the first tube. The nozzle can comprise a nozzle cavity that may be in fluid communication with the first channel. The nozzle can receive the first cooling fluid and direct the first cooling fluid toward the travel path.

In some embodiments, the first tube can comprise a first cross-sectional size at a first location between the first end and the second end, and a second cross-sectional size at a second location adjacent to the second end. The first cross-sectional size can be different than the second cross-sectional size.

In some embodiments, the first cross-sectional size can be greater than the second cross-sectional size.

In some embodiments, the first tube and the second tube may be coaxial and extend along a longitudinal axis.

In some embodiments, an axis that may be orthogonal to the longitudinal axis can intersect the closed first sidewall and the closed second sidewall.

In some embodiments, the closed first sidewall can isolate the first channel from the second channel.

In accordance with some embodiments, methods of manufacturing a glass ribbon can comprise forming a ribbon of glass-forming material. Methods can comprise moving the ribbon of glass-forming material along a travel path in a travel direction. Methods can comprise delivering a first cooling fluid through a first tube toward a nozzle. Methods can comprise cooling the first tube by delivering a second cooling fluid through a second tube that surrounds the first tube such that the second cooling fluid is in convective contact with the first tube. Methods can comprise cooling an area of the ribbon of glass-forming material by directing the first cooling fluid from an end of the first tube and through the nozzle toward the area of the ribbon of glass-forming material.

In some embodiments, methods can comprise isolating the first cooling fluid from the second cooling fluid when the second cooling fluid is delivered through the second tube and when the first cooling fluid is directed from the end of the first tube.

In some embodiments, the cooling the first tube can comprise thermally shielding the first tube from a surrounding environment by absorbing heat from the surrounding environment with the second cooling fluid.

In some embodiments, methods can comprise controlling a phase change of the first cooling fluid within the first tube by accelerating a flow of the first cooling fluid within a first portion of the first tube prior to reaching the end of the first tube.

In some embodiments, the accelerating can comprise reducing a cross-sectional size of the first portion of the first tube relative to a flow direction of the first cooling fluid.

In some embodiments, the accelerating can comprise enabling a phase change of a portion of the first cooling fluid within the first portion from one or more of a liquid phase or a solid phase to a gas phase.

In some embodiments, the cooling the area can comprise changing a phase of the first cooling fluid while the first cooling fluid is flowing toward the area of the ribbon of glass-forming material.

In some embodiments, the first cooling fluid comprises carbon dioxide.

In accordance with some embodiments, methods of manufacturing a glass ribbon can comprise forming a ribbon of glass-forming material. Methods can comprise moving the ribbon of glass-forming material along a travel path in a travel direction. Methods can comprise delivering a first cooling fluid through a first tube toward a nozzle. Methods can comprise controlling a phase change of the first cooling fluid within the first tube by accelerating a flow of the first cooling fluid within a first portion of the first tube prior to reaching the nozzle. Methods can comprise cooling an area of the ribbon of glass-forming material by directing the first cooling fluid from an end of the first tube and through the nozzle toward the area of the ribbon of glass-forming material.

In some embodiments, the accelerating can comprise reducing a cross-sectional size of the first portion of the first tube relative to a flow direction of the first cooling fluid.

In some embodiments, the accelerating can comprise enabling a phase change of a portion of the first cooling fluid within the first portion from one or more of a liquid phase or a solid phase to a gas phase.

In some embodiments, the cooling the area can comprise changing a phase of the first cooling fluid while the first cooling fluid is flowing toward the area.

In some embodiments, the first cooling fluid can comprise carbon dioxide.

In some embodiments, methods can comprise extracting the first cooling fluid by suction after the first cooling fluid has been directed from the end of the first tube and through the nozzle.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings. It is to be understood that both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

These and other features, embodiments and advantages are better understood when the following detailed description is read with reference to the accompanying drawings, in which:

FIG. 1 schematically illustrates example embodiments of a glass manufacturing apparatus in accordance with embodiments of the disclosure;

FIG. 2 illustrates a perspective cross-sectional view of the glass manufacturing apparatus along line 2-2 of FIG. 1 in accordance with embodiments of the disclosure;

FIG. 3 illustrates a cross-sectional view similar to FIG. 2 of the glass manufacturing apparatus comprising one or more cooling apparatuses for cooling a ribbon of glass-forming material in accordance with embodiments of the disclosure;

FIG. 4 illustrates a cross-sectional view along line 4-4 of FIG. 3 of a first cooling apparatus in accordance with embodiments of the disclosure;

FIG. 5 illustrates a cross-sectional view along line 5-5 of FIG. 4 of the first cooling apparatus comprising a first tube and a second tube in accordance with embodiments of the disclosure;

FIG. 6 illustrates a cross-sectional view of the first cooling apparatus similar to FIG. 5 with one or more coolant particles being emitted from the first tube toward the ribbon of glass-forming material in accordance with embodiments of the disclosure;

FIG. 7 illustrates a cross-sectional view along line 5-5 of FIG. 4 of additional embodiments of a first cooling apparatus comprising a first tube with a non-constant cross-sectional size in accordance with embodiments of the disclosure;

FIG. 8 illustrates a cross-sectional view of the first cooling apparatus similar to FIG. 7 with one or more coolant particles being emitted from the first tube toward the ribbon of glass-forming material in accordance with embodiments of the disclosure; and

FIG. 9 illustrates a cross-sectional view along line 5-5 of FIG. 4 of additional embodiments of a first cooling apparatus comprising a first cooling fluid that cools a first tube in accordance with embodiments of the disclosure.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

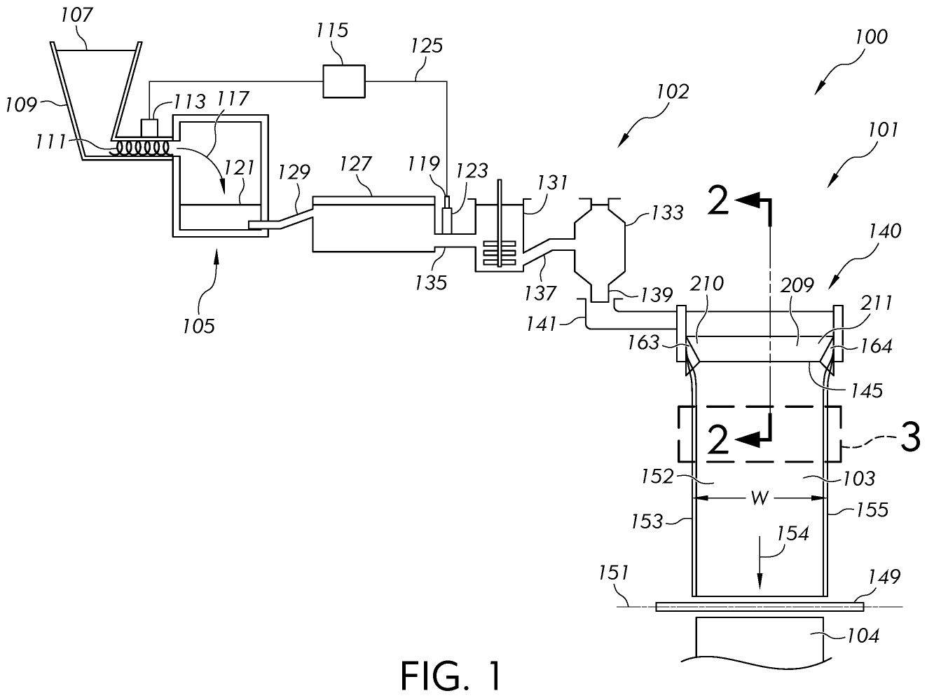

The present disclosure relates to a glass manufacturing apparatus and methods for producing a glass ribbon. Methods and apparatus for producing a glass ribbon from a ribbon of glass-forming material will now be described by way of example embodiments. As schematically illustrated in FIG. 1, in some embodiments, an exemplary glass manufacturing apparatus 100 can comprise a glass melting and delivery apparatus 102 and a forming apparatus 101 comprising a forming vessel 140 designed to produce a ribbon of glass-forming material 103 from a quantity of molten material 121. In some embodiments, the ribbon of glass-forming material 103 can comprise a central portion 152 positioned between opposite edge portions (e.g., edge beads) formed along a first outer edge 153 and a second outer edge 155 of the ribbon of glass-forming material 103, wherein a thickness of the edge portions can be greater than a thickness of the central portion. Additionally, in some embodiments, a separated glass ribbon 104 can be separated from the ribbon of glass-forming material 103 along a separation path 151 by a glass separator 149 (e.g., scribe, score wheel, diamond tip, laser, etc.).

In some embodiments, the glass melting and delivery apparatus 102 can comprise a melting vessel 105 oriented to receive batch material 107 from a storage bin 109. The batch material 107 can be introduced by a batch delivery device 111 powered by a motor 113. In some embodiments, an optional controller 115 can be operated to activate the motor 113 to introduce a desired amount of batch material 107 into the melting vessel 105, as indicated by arrow 117. The melting vessel 105 can heat the batch material 107 to provide molten material 121. In some embodiments, a melt probe 119 can be employed to measure a level of molten material 121 within a standpipe 123 and communicate the measured information to the controller 115 by way of a communication line 125.

Additionally, in some embodiments, the glass melting and delivery apparatus 102 can comprise a first conditioning station comprising a fining vessel 127 located downstream from the melting vessel 105 and coupled to the melting vessel 105 by way of a first connecting conduit 129. In some embodiments, molten material 121 can be gravity fed from the melting vessel 105 to the fining vessel 127 by way of the first connecting conduit 129. For example, in some embodiments, gravity can drive the molten material 121 through an interior pathway of the first connecting conduit 129 from the melting vessel 105 to the fining vessel 127. Additionally, in some embodiments, bubbles can be removed from the molten material 121 within the fining vessel 127 by various techniques.

In some embodiments, the glass melting and delivery apparatus 102 can further comprise a second conditioning station comprising a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In some embodiments, molten material 121 can be gravity fed from the fining vessel 127 to the mixing chamber 131 by way of the second connecting conduit 135. For example, in some embodiments, gravity can drive the molten material 121 through an interior pathway of the second connecting conduit 135 from the fining vessel 127 to the mixing chamber 131.

Additionally, in some embodiments, the glass melting and delivery apparatus 102 can comprise a third conditioning station comprising a delivery chamber 133 that can be located downstream from the mixing chamber 131. In some embodiments, the delivery chamber 133 can condition the molten material 121 to be fed into an inlet conduit 141. For example, the delivery chamber 133 can function as an accumulator and/or flow controller to adjust and provide a consistent flow of molten material 121 to the inlet conduit 141. As shown, the mixing chamber 131 can be coupled to the delivery chamber 133 by way of a third connecting conduit 137. In some embodiments, molten material 121 can be gravity fed from the mixing chamber 131 to the delivery chamber 133 by way of the third connecting conduit 137. For example, in some embodiments, gravity can drive the molten material 121 through an interior pathway of the third connecting conduit 137 from the mixing chamber 131 to the delivery chamber 133. As further illustrated, in some embodiments, a delivery pipe 139 can be positioned to deliver molten material 121 to forming apparatus 101, for example the inlet conduit 141 of the forming vessel 140.

Forming apparatus 101 can comprise various embodiments of forming vessels in accordance with features of the disclosure, for example, a forming vessel with a wedge for fusion drawing the glass ribbon, a forming vessel with a slot to slot draw the glass ribbon, or a forming vessel provided with press rolls to press roll the glass ribbon from the forming vessel. In some embodiments, the forming apparatus 101 can comprise a sheet redraw, for example, with the forming apparatus 101 as part of a redraw process. For example, the glass ribbon 104, which can comprise a first thickness, may be heated up and redrawn to achieve a thinner glass ribbon 104 comprising a smaller second thickness. By way of illustration, the forming vessel 140 shown and disclosed below can be provided to fusion draw molten material 121 off a bottom edge, defined as a root 145, of a forming wedge 209 to produce the ribbon of glass-forming material 103. For example, in some embodiments, the molten material 121 can be delivered from the inlet conduit 141 to the forming vessel 140. The molten material 121 can then be formed into the ribbon of glass-forming material 103 based, in part, on the structure of the forming vessel 140. For example, as shown, the molten material 121 can be drawn off the bottom edge (e.g., root 145) of the forming vessel 140 along a draw path extending in a travel direction 154 of the glass manufacturing apparatus 100. In some embodiments, edge directors 163, 164 can direct the molten material 121 off the forming vessel 140 and define, in part, a width “W” of the ribbon of glass-forming material 103. In some embodiments, the width “W” of the ribbon of glass-forming material 103 extends between the first outer edge 153 of the ribbon of glass-forming material 103 and the second outer edge 155 of the ribbon of glass-forming material 103.

In some embodiments, the width “W” of the ribbon of glass-forming material 103, which extends between the first outer edge 153 of the ribbon of glass-forming material 103 and the second outer edge 155 of the ribbon of glass-forming material 103, can be greater than or equal to about 20 millimeters (mm), for example, greater than or equal to about 50 mm, for example, greater than or equal to about 100 mm, for example, greater than or equal to about 500 mm, for example, greater than or equal to about 1000 mm, for example, greater than or equal to about 2000 mm, for example, greater than or equal to about 3000 mm, for example, greater than or equal to about 4000 mm, although other widths less than or greater than the widths mentioned above can be provided in further embodiments. For example, in some embodiments, the width “W” of the ribbon of glass-forming material 103 can be within a range from about 20 mm to about 4000 mm, for example, within a range from about 50 mm to about 4000 mm, for example, within a range from about 100 mm to about 4000 mm, for example, within a range from about 500 mm to about 4000 mm, for example, within a range from about 1000 mm to about 4000 mm, for example, within a range from about 2000 mm to about 4000 mm, for example, within a range from about 3000 mm to about 4000 mm, for example, within a range from about 20 mm to about 3000 mm, for example, within a range from about 50 mm to about 3000 mm, for example, within a range from about 100 mm to about 3000 mm, for example, within a range from about 500 mm to about 3000 mm, for example, within a range from about 1000 mm to about 3000 mm, for example, within a range from about 2000 mm to about 3000 mm, for example, within a range from about 2000 mm to about 2500 mm, and all ranges and subranges therebetween.

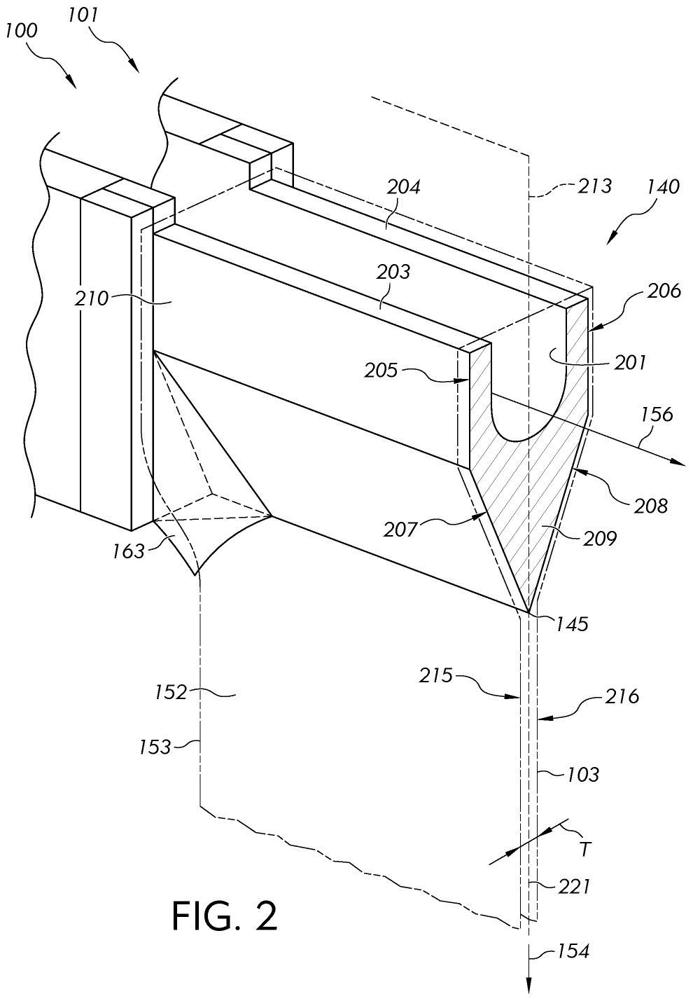

FIG. 2 shows a cross-sectional perspective view of the forming apparatus 101 (e.g., forming vessel 140) along line 2-2 of FIG. 1. In some embodiments, the forming vessel 140 can comprise a trough 201 oriented to receive the molten material 121 from the inlet conduit 141. For illustrative purposes, cross-hatching of the molten material 121 is removed from FIG. 2 for clarity. The forming vessel 140 can further comprise the forming wedge 209 comprising a pair of downwardly inclined converging surface portions 207, 208 extending between opposed ends 210, 211 (See FIG. 1) of the forming wedge 209. The pair of downwardly inclined converging surface portions 207, 208 of the forming wedge 209 can converge along the travel direction 154 to intersect along the root 145 of the forming vessel 140. A draw plane 213 of the glass manufacturing apparatus 100 can extend through the root 145 along the travel direction 154. In some embodiments, the ribbon of glass-forming material 103 can be drawn in the travel direction 154 along the draw plane 213. As shown, the draw plane 213 can bisect the forming wedge 209 through the root 145 although, in some embodiments, the draw plane 213 can extend at other orientations relative to the root 145. In some embodiments, the ribbon of glass-forming material 103 can move along a travel path 221 that may be co-planar with the draw plane 213 in the travel direction 154.

Additionally, in some embodiments, the molten material 121 can flow in a direction 156 into and along the trough 201 of the forming vessel 140. The molten material 121 can then overflow from the trough 201 by flowing over corresponding weirs 203, 204 and downward over the outer surfaces 205, 206 of the corresponding weirs 203, 204. Respective streams of molten material 121 can then flow along the downwardly inclined converging surface portions 207, 208 of the forming wedge 209 and be drawn off the root 145 of the forming vessel 140, where the flows converge and fuse into the ribbon of glass-forming material 103. The ribbon of glass-forming material 103 can then be drawn along the travel direction 154. In some embodiments, the ribbon of glass-forming material 103 comprises one or more states of material based on a vertical location of the ribbon of glass-forming material 103. For example, at a first location, the ribbon of glass-forming material 103 can comprise the viscous molten material 121, and at a second location, the ribbon of glass-forming material 103 can comprise an amorphous solid in a glassy state (e.g., a glass ribbon).

The ribbon of glass-forming material 103 comprises a first major surface 215 and a second major surface 216 facing opposite directions and defining a thickness “T” (e.g, average thickness) of the ribbon of glass-forming material 103 therebetween. In some embodiments, the thickness “T’ of the ribbon of glass-forming material 103 can be less than or equal to about 2 millimeters (mm), less than or equal to about 1 millimeter, less than or equal to about 0.5 millimeters, for example, less than or equal to about 300 micrometers (μm), less than or equal to about 200 micrometers, or less than or equal to about 100 micrometers, although other thicknesses may be provided in further embodiments. For example, in some embodiments, the thickness “T’ of the ribbon of glass-forming material 103 can be within a range from about 20 micrometers to about 200 micrometers, within a range from about 50 micrometers to about 750 micrometers, within a range from about 100 micrometers to about 700 micrometers, within a range from about 200 micrometers to about 600 micrometers, within a range from about 300 micrometers to about 500 micrometers, within a range from about 50 micrometers to about 500 micrometers, within a range from about 50 micrometers to about 700 micrometers, within a range from about 50 micrometers to about 600 micrometers, within a range from about 50 micrometers to about 500 micrometers, within a range from about 50 micrometers to about 400 micrometers, within a range from about 50 micrometers to about 300 micrometers, within a range from about 50 micrometers to about 200 micrometers, within a range from about 50 micrometers to about 100 micrometers, within a range from about 25 micrometers to about 125 micrometers, comprising all ranges and subranges of thicknesses therebetween. In addition, the ribbon of glass-forming material 103 can comprise a variety of compositions, for example, borosilicate glass, alumino-borosilicate glass, alkali-containing glass, or alkali-free glass, alkali aluminosilicate glass, alkaline earth aluminosilicate glass, soda-lime glass, etc.

In some embodiments, the glass separator 149 (see FIG. 1) can separate the glass ribbon 104 from the ribbon of glass-forming material 103 along the separation path 151 to provide a plurality of separated glass ribbons 104 (i.e., a plurality of sheets of glass). According to other embodiments, a longer portion of the glass ribbon 104 may be coiled onto a storage roll. The separated glass ribbon can then be processed into a desired application, e.g, a display application. For example, the separated glass ribbon can be used in a wide range of display applications, comprising liquid crystal displays (LCDs), electrophoretic displays (EPD), organic light emitting diode displays (OLEDs), plasma display panels (PDPs), touch sensors, photovoltaics, and other electronic displays.

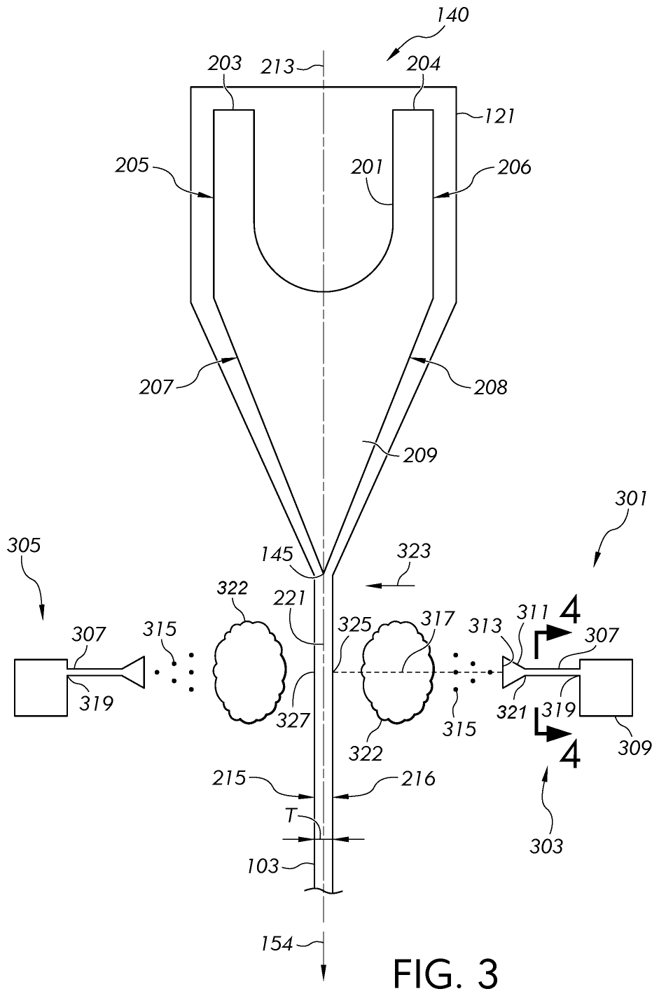

FIG. 3 illustrates a cross-sectional perspective view of the glass manufacturing apparatus 100 similar to FIG. 2. In some embodiments, the glass manufacturing apparatus 100 is not limited to comprising the forming wedge 209. Rather, in some embodiments, although not shown, the forming vessel 140 can comprise a pipe oriented to receive the molten material 121 from the inlet conduit 141 (e.g., the inlet conduit 141 illustrated in FIG. 1). In some embodiments, the pipe can comprise a slot through which the molten material 121 can flow. For example, the slot can comprise an elongated slot that extends along an axis of the pipe at the top of the pipe. In some embodiments, a first wall can be attached to the pipe at a first peripheral location and a second wall can be attached to the pipe at a second peripheral location. The first wall and the second wall can comprise a pair of downwardly inclined converging surface portions. The first wall and the second wall can also at least partially define a hollow region within the forming vessel. In some embodiments, a pipe wall comprising the pipe, the first wall, and/or the second wall can comprise a thickness in a range from about 0.5 mm to about 10 mm, from about 0.5 mm to about 7 mm, from about 0.5 mm to about 3 mm, from about 1 mm to about 10 mm, from about 1 mm to about 7 mm, from about 3 mm to about 10 mm, from about 3 mm to about 7 mm, or any range or subrange therebetween. A thickness in the above range can result in overall reduced material costs compared to embodiments comprising thicker walls.

As illustrated in FIG. 3, the glass manufacturing apparatus 100 can comprise one or more cooling apparatuses 301 for cooling an area of the ribbon of glass-forming material 103. For example, in some embodiments, the one or more cooling apparatuses 301 can comprise a first cooling apparatus 303, a second cooling apparatus 305, etc. The first cooling apparatus 303 can be positioned on a first side of the draw plane 213, and the second cooling apparatus 305 can be positioned on a second side of the draw plane 213. The draw plane 213 (e.g., and, thus, the ribbon of glass-forming material 103) can therefore extend between the first cooling apparatus 303 and the second cooling apparatus 305. Although two cooling apparatuses are shown, the one or more cooling apparatuses 301 can comprise additional cooling apparatuses, for example, with cooling apparatuses located upstream or downstream from the first cooling apparatus 303 and/or the second cooling apparatus 305 relative to the travel direction 154. In some embodiments, the first cooling apparatus 303 and the second cooling apparatus 305 may be substantially identical. As such, the description herein of the structure and function of the first cooling apparatus 303 is applicable to the second cooling apparatus 305 and other cooling apparatuses.

With reference to the first cooling apparatus 303, the first cooling apparatus 303 can comprise a cooling tube 307 that can comprise a first end 319 and a second end 321, wherein the second end 321 may be opposite the first end 319. In some embodiments, the second end 321 may be positioned adjacent to the travel path 221. For example, by being positioned adjacent to the travel path 221, the second end 321 may be closer in proximity to the travel path 221 than the first end 319 is in proximity to the travel path 221, such that the first cooling apparatus 303 can emit a cooling fluid (e.g., coolant particles 315 that undergo a phase change into a gas 322) toward the ribbon of glass-forming material 103 to cause cooling of an area 325 of the ribbon of glass-forming material 103. For example, with the second end 321 adjacent to the travel path 221, the coolant particles 315 can be emitted from the second end 321, whereupon the coolant particles 315 may undergo a phase change (e.g., from a solid or a liquid) into the gas 322 as a result of the elevated temperature near the travel path 221. The phase change can cause the area 325 to cool. In some embodiments, the cooling tube 307 can be in fluid communication with a coolant source 309, such that the cooling tube 307 can receive a cooling fluid from the coolant source 309. For example, the coolant source 309 can comprise a pump, a canister, a cartridge, a boiler, a compressor, and/or a pressure vessel. In some embodiments, the coolant source 309 may store the cooling fluid in one or more of a gas phase, a liquid phase, or a solid phase.

In some embodiments, the cooling tube 307 can comprise a nozzle 311. The nozzle 311 can be attached to and/or in fluid communication with the second end 321. The nozzle 311 can receive the cooling fluid from the second end 321, whereupon the cooling fluid can exit an outlet 313 of the nozzle 311. In some embodiments, the cooling fluid can exit the outlet 313 and can flow in a flow direction 323 along a central axis 317 toward the draw plane 213 (e.g., and, thus, the ribbon of glass-forming material 103). The central axis 317 can intersect the nozzle 311 and the travel path 221. For example, in some embodiments, the central axis 317 may be substantially perpendicular to the travel path 221. However, in some embodiments, the central axis 317 may not be perpendicular to the travel path 221, and may form an angle relative to the travel path 221 that is greater than or less than 90 degrees. In some embodiments, the cooling fluid may comprise one or more coolant particles 315 as the cooling fluid exits the outlet 313. In some embodiments, the one or more coolant particles 315 can comprise liquid and/or solid particles. The one or more coolant particles 315 can undergo a phase change, such as to the gas 322, after the cooling fluid has exited the outlet 313 and as the one or more coolant particles 315 travel in the flow direction 323 along the central axis 317. In some embodiments, the first cooling apparatus 303 can reduce a temperature of the ribbon of glass-forming material 103 at the area 325, and the second cooling apparatus 305 can reduce a temperature of the ribbon of glass-forming material 103 at an area 327.

In some embodiments, methods of manufacturing a glass ribbon can comprise forming the ribbon of glass-forming material 103 and moving the ribbon of glass-forming material 103 along the travel path 221 in the travel direction 154. For example, the ribbon of glass-forming material 103 can be formed by overflowing the molten material 121 (e.g., illustrated in FIG. 1) from the trough 201 by flowing over the weirs 203, 204 and downward over the outer surfaces 205, 206. In some embodiments, the ribbon of glass-forming material 103 can move downwardly in the travel direction 154 along the travel path 221. As the ribbon of glass-forming material 103 moves along the travel path 221, the ribbon of glass-forming material 103 can move past the first cooling apparatus 303 and the second cooling apparatus 305. The first cooling apparatus 303 and the second cooling apparatus 305 may be adjacent to the ribbon of glass-forming material 103, such that as the ribbon of glass-forming material 103 moves in the travel direction 154, one or more portions of the ribbon of glass-forming material 103 may be cooled by the first cooling apparatus 303 and/or the second cooling apparatus 305.

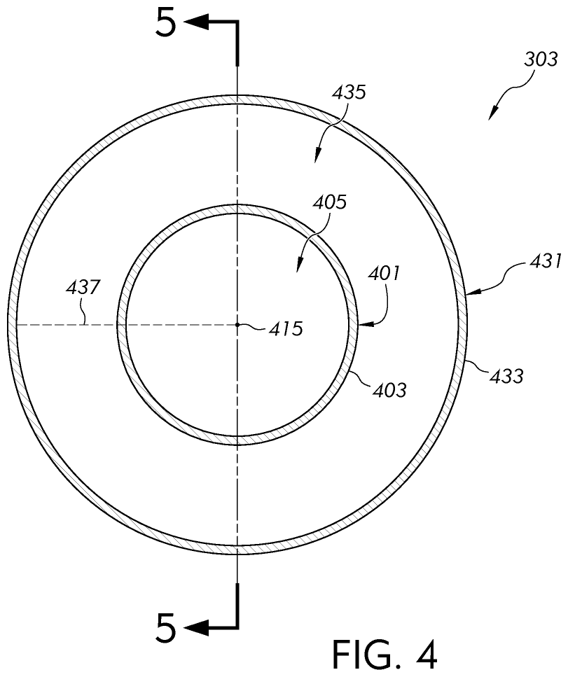

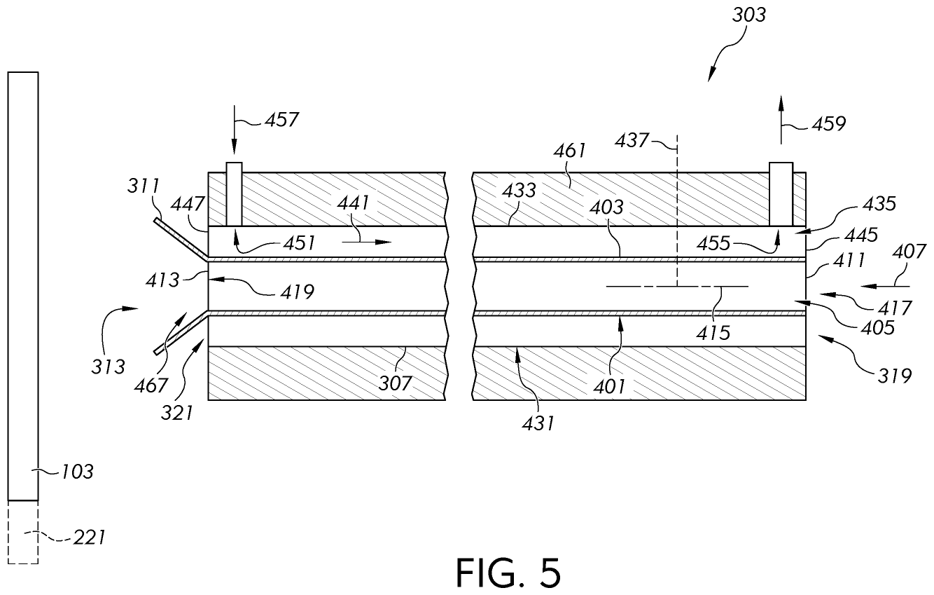

FIG. 4 illustrates a sectional view of the cooling tube 307 of the first cooling apparatus 303 along line 4-4 of FIG. 3. FIG. 5 illustrates a sectional view of the cooling tube 307 of the first cooling apparatus 303 along line 5-5 of FIG. 4. Referring to FIGS. 4-5, the cooling tube 307 can comprise a first tube 401. The first tube 401 can comprise a closed first sidewall 403 that surrounds a first channel 405. In some embodiments, the first tube 401 can receive a first cooling fluid 407 (e.g., from the coolant source 309 illustrated in FIG. 3) within the first channel 405. By being closed, the closed first sidewall 403 may be free of openings, orifices, voids, vents, or the like, such that the first cooling fluid 407 may be prevented from exiting the first channel 405 by passing through the closed first sidewall 403. In some embodiments, the closed first sidewall 403 may define a hollow interior that can form the first channel 405.

The first tube 401 can extend between a first end 411 and a second end 413. The first end 411 may be in attachment with and/or in fluid communication with the coolant source 309 of FIG. 3. The second end 413, which may be located at an opposite end of the first tube 401 from the first end 411, may be positioned adjacent to and facing the ribbon of glass-forming material 103. The first tube 401 may therefore comprise an inlet 417 located at the first end 411 and an outlet 419 located at the second end 413. The first tube 401 may receive the first cooling fluid 407 within the first channel 405 through the inlet 417 at the first end 411. The first cooling fluid 407 can exit the first tube 401 from the first channel 405 through the outlet 419 at the second end 413. In some embodiments, the first tube 401 can comprise a thermally conductive material, such as one or more of stainless steel, nickel alloys, titanium alloys, molybdenum alloys, tungsten alloys or cobalt alloys. For example, the thermal conductivity of stainless steel may be about

$$16.3 \frac{watts}{meter \times kelvin} ,$$

the thermal conductivity of a nickel alloy may be about

$$91 \frac{watts}{meter \times kelvin} ,$$

the thermal conductivity of a titanium alloy may be within a range from about

$$6 \frac{watts}{meter \times kelvin}$$

to about

$$22 \frac{watts}{meter \times kelvin} ,$$

the thermal conductivity of a molybdenum alloy may be about

$$138 \frac{watts}{meter \times kelvin} ,$$

the thermal conductivity of a tungsten alloy may be about

$$174 \frac{watts}{meter \times kelvin} ,$$

and the thermal conductivity of a cobalt alloy may be about

$$100 \frac{watts}{meter \times kelvin} .$$

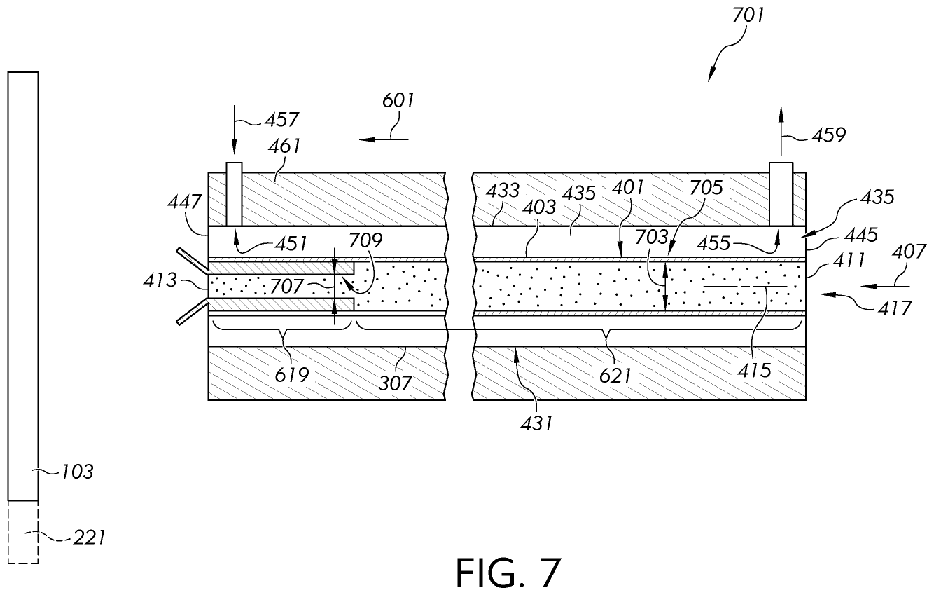

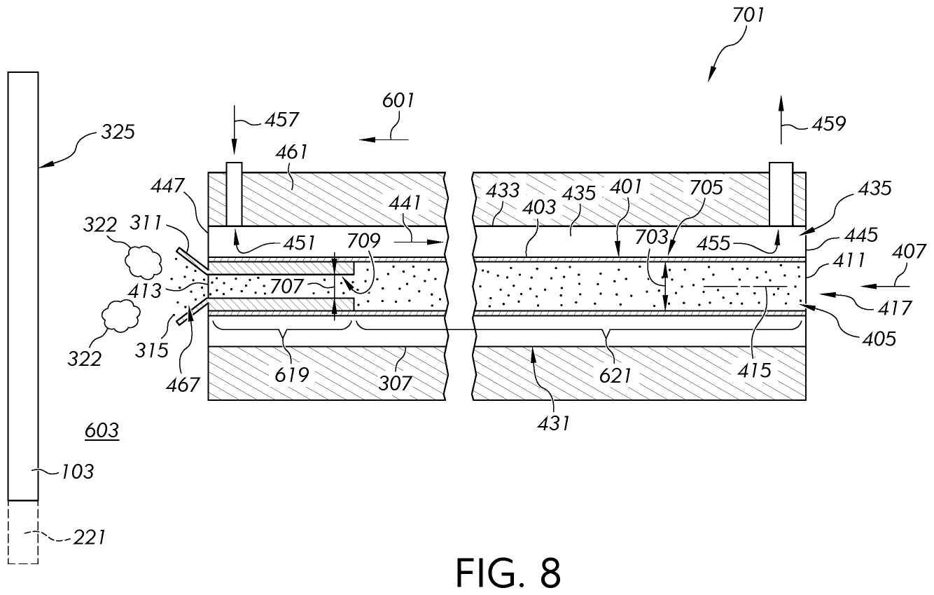

Due to the first tube 401 comprising a metal material in some embodiments, the first tube 401 may be thermally conductive, and, thus, may efficiently conduct heat. In some embodiments, the first tube 401 can comprise a substantially constant cross-sectional size between the first end 411 and the second end 413. The cross-sectional size of the first tube 401 may be measured between an inner surface of the closed first sidewall 403 along an axis that is perpendicular to a longitudinal axis 415 along which the first tube 401 extends. For example, the first tube 401 may comprise a circular cross-sectional shape such that the first tube 401 can comprise a substantially constant diameter between the first end 411 and the second end 413. In some embodiments, the cross-sectional size (e.g., diameter) across the inner surface of the first tube 401 can be within a range from about 0.05 mm to about 2 mm, or within a range from about 0.25 mm to about 0.75 mm. The cross-sectional size of the first tube 401 can be selected such that a pressure drop between the first end 411 and the second end 413 can be achieved, wherein the pressure drop can assist in maintaining a phase (e.g., liquid phase or solid phase) of the first cooling fluid 407 within the first tube 401. However, the first tube 401 is not limited to a constant cross-sectional size, and as illustrated and described relative to FIGS. 7-8, in some embodiments, the first tube 401 may comprise a non-constant cross-sectional size.

In some embodiments, the cooling tube 307 can comprise a second tube 431. The second tube 431 can comprise a closed second sidewall 433 surrounding a second channel 435. The first tube 401 can be positioned within the second tube 431 such that the second channel 435 may be between the closed first sidewall 403 and the closed second sidewall 433. For example, by being positioned within, the first tube 401 may be received within an interior of the second tube 431, such that the second tube 431 may comprise a cross-sectional size (e.g, diameter) that is larger than a cross-sectional size (e.g., diameter) of the first tube 401). In some embodiments, the first tube 401 and the second tube 431 may be coaxial and can extend along the longitudinal axis 415. In some embodiments, an axis 437 that is orthogonal to the longitudinal axis 415 can intersect the closed first sidewall 403 and the closed second sidewall 433. For example, originating at the longitudinal axis 415, the axis 437 can first pass through the first channel 405, followed by the closed first sidewall 403, followed by the second channel 435 (e.g., which is located between the closed first sidewall 403 and the closed second sidewall 433), followed by the closed second sidewall 433.

In some embodiments, the second tube 431 can receive a second cooling fluid 441 within the second channel 435, whereupon the second cooling fluid 441 can flow within the second channel 435 between the closed first sidewall 403 and the closed second sidewall 433. For example, the second channel 435 may be hollow and void of other structures such that a space (e.g., the second channel 435) may be located between the first tube 401 and the second tube 431. By being closed, the closed second sidewall 433 may be free of openings, orifices, voids, vents, or the like, such that the second cooling fluid 441 may be prevented from exiting the second channel 435 by passing through the closed second sidewall 433. With the closed first sidewall 403 also free of openings, the second cooling fluid 441 may remain within the second channel 435 and may not pass through the closed first sidewall 403. The second tube 431 can extend between a first end 445 and a second end 447. In some embodiments, the second end 447, which may be located at an opposite end of the second tube 431 from the first end 445, may be positioned adjacent to the ribbon of glass-forming material 103. In some embodiments, the second tube 431 can comprise an inlet 451 and an outlet 455. The inlet 451 can comprise an opening for an ingress 457 of the second cooling fluid 441 such that the second cooling fluid 441 can enter the second channel 435 by flowing through the inlet 451. The outlet 455 can comprise an opening for an egress 459 of the second cooling fluid 441 such that the second cooling fluid 441 can exit the second channel 435 by flowing through the outlet 455. In some embodiments, the inlet 451 can be positioned adjacent to the second end 447 of the second tube 431, and the outlet 455 can be positioned adjacent to the first end 445 of the second tube 431. For example, in some embodiments, the second tube 431 can be positioned within a refractory material 461, such that the refractory material 461 can surround the second tube 431. In some embodiments, the refractory material 461 may not surround the nozzle 311 (e.g., as illustrated in FIG. 4), though, in some embodiments, the refractory material 461 can surround the nozzle 311. When the refractory material 461 surrounds the nozzle 311, the ingress 457 can allow for the second cooling fluid 441 to cool the walls of the nozzle 311. In some embodiments, the inlet 451 can be in fluid communication with an opening in the refractory material 461, such that the ingress 457 of the second cooling fluid 441 can flow through the opening in the refractory material 461 and through the inlet 451. After flowing through the second channel 435, the second cooling fluid 441 can exit the second channel 435 by exiting through the outlet 455. In some embodiments, a second opening can be formed in the refractory material 461, wherein the second opening may be in fluid communication with the outlet 455. The egress 459 of the second cooling fluid 441 can therefore flow through the outlet 455 and through the second opening in the refractory material 461. In some embodiments, the second cooling fluid 441 can flow in the same direction, or an opposing direction (e.g., as illustrated in FIG. 5), from the first cooling fluid 407.

In some embodiments, the second tube 431 can comprise a substantially constant cross-sectional size between the first end 445 and the second end 447. The cross-sectional size of the second tube 431 may be measured between an inner surface of the closed second sidewall 433 along the axis 437 that is perpendicular to the longitudinal axis 415. For example, the second tube 431 may comprise a circular cross-sectional shape such that the second tube 431 can comprise a substantially constant diameter between the first end 445 and the second end 447. However, the second tube 431 is not so limited, and in some embodiments, the second tube 431 may comprise a non-constant cross-sectional size. The second tube 431 can comprise a larger cross-sectional size than the cross-sectional size of the first tube 401 such that the first tube 401 can be received within the second tube 431.

In some embodiments, the cooling tube 307 can comprise the nozzle 311 attached to the first tube 401. For example, in some embodiments, the nozzle 311 can be attached to the second end 413 of the closed first sidewall 403. In some embodiments, by being attached to the first tube 401, the nozzle 311 can be one-piece formed with the closed first sidewall 403. In some embodiments, the nozzle 311 can be attached to the closed first sidewall 403 while not being one-piece formed. For example, one or more mechanical fasteners can attach the nozzle 311 and the closed first sidewall 403. The mechanical fasteners may comprise, for example, adhesives, locking structures (e.g., male-female threading engagement), a welding attachment, etc., such that the nozzle 311 is limited from being inadvertently detached from the closed first sidewall 403 during operation. The refractory material 461 may surround none, some or all of the nozzle 311. For example, in some embodiments, the refractory material 461 may surround some of or all of the nozzle 311, while in other embodiments, the refractory material 461 may not surround the nozzle 311.

The nozzle 311 can comprise a nozzle cavity 467 that may be in fluid communication with the first channel 405. For example, by being in fluid communication, the nozzle 311 can receive the first cooling fluid 407 (e.g., within the nozzle cavity 467) and direct the first cooling fluid 407 toward the travel path 221. In some embodiments, the nozzle cavity 467 may be substantially hollow and can form a chamber within which the first cooling fluid 407 enters after the first cooling fluid 407 exits the second end 413 of the closed first sidewall 403. The nozzle 311 can comprise several different shapes, for example a conical shape, an elongated conical shape comprising a width (e.g., along the direction of the width W illustrated in FIG. 1) that is greater than a height (e.g., along the travel direction 154 illustrated in FIG. 1), etc.

In some embodiments, the nozzle 311 can comprise a diffuser. In some embodiments, a diffuser may comprise a wall defining an opening through which a fluid can pass. The wall opening can comprise an increasing cross-sectional size relative to a flow direction of the fluid, such that the velocity of the fluid can decrease within the diffuser. Without wishing to be bound by theory, a diffuser can decrease (e.g., reduce) the velocity of the first cooling fluid 407 in the nozzle 311, which can inhibit (e.g., reduce, decrease, eliminate) the chance that the first cooling fluid 407 contacts a surface of the ribbon of glass-forming material 103. Additionally, without wishing to be bound by theory, a diffuser can decrease the temperature of the first cooling fluid 407 flowing through the diffuser when the first cooling fluid 407 comprises a negative Joule-Thomson coefficient. In some embodiments, an atomizer may be positioned between the coolant source 309 and the nozzle 311 to generate particles (e.g., liquid droplets, solid particles).

In some embodiments, the nozzle 311 can comprise a boiling nozzle. In some embodiments, a boiling nozzle can comprise an inlet section that is converging (e.g., decreasing cross-sectional size) relative to a flow direction of the fluid, followed by an outlet section that is diverging (e.g., increasing cross-sectional size) relative to the flow direction of the fluid. Without wishing to be bound by theory, a boiling nozzle may generate particles (e.g., liquid droplets, solid particles) using the kinetic energy (e.g., acceleration) of the first cooling fluid 407 to separate the first cooling fluid 407 into particles. In some embodiments, portions of the first cooling fluid 407 may undergo a phase transformation to a gas (e.g., “boil”) when accelerated by a boiling nozzle. In some embodiments, portions of the first cooling fluid 407 may separate from one another based on the surface tension of the first cooling fluid 407 as the first cooling fluid 407 is thinned during acceleration in the nozzle 311.

In some embodiments, the nozzle 311 can comprise a shear nozzle. In some embodiments, a shear nozzle can comprise a surface that forms a spiral upon which a fluid can impinge, such that the fluid can be separated into particles. Without wishing to be bound by theory, a shear nozzle may generate particles (e.g., liquid droplets, solid particles) from the first cooling fluid 407. In some embodiments, the shear nozzle can induce a rotary fluid motion that can cause the first cooling fluid 407 to separate into particles based on the shear forces introduce therein. In further embodiments, a shear nozzle can form particles (e.g., liquid droplets, solid particles) by combining the first cooling fluid 407 and another fluid (e.g., gas). In even further embodiments, the first cooling fluid 407 may be circumscribed by another fluid within the shear nozzle. Without wishing to be bound by theory, shearing between the first cooling fluid 407 and the other fluid can produce particles of coolant.

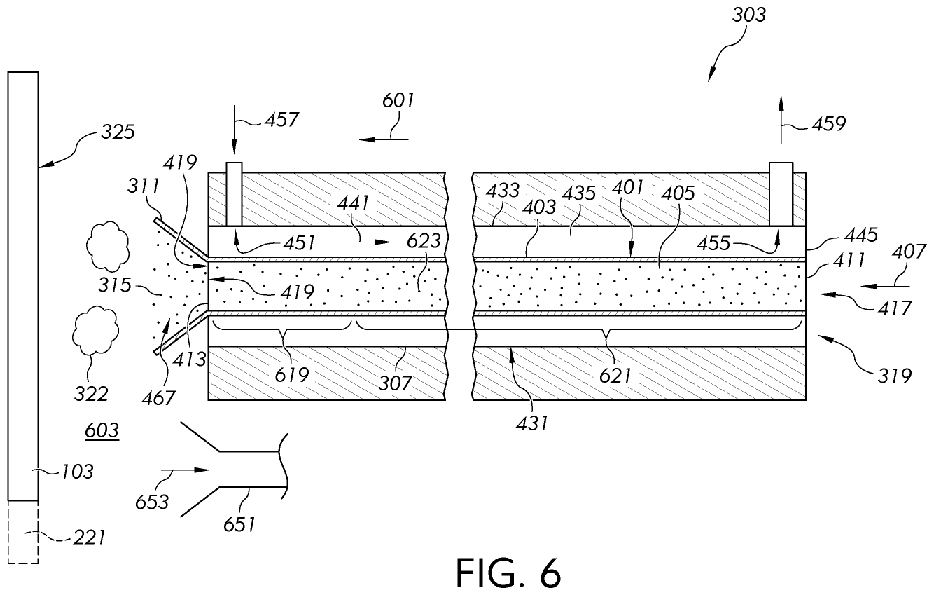

Referring to FIG. 6, in some embodiments, methods of manufacturing a glass ribbon can comprise delivering the first cooling fluid 407 through the first tube 401 toward the nozzle 311. For example, the first cooling fluid 407 can be supplied by the coolant source 309 (e.g., illustrated in FIG. 3). The coolant source 309 can deliver the first cooling fluid 407 through the inlet 417 at the first end 411 and into the first channel 405. The first cooling fluid 407 can flow in a flow direction 601 from the first end 411 toward the second end 413. Upon reaching the second end 413, the first cooling fluid 407 can exit the first channel 405 through the outlet 419 and may enter the nozzle 311 by being received within the nozzle cavity 467. In some embodiments, the first cooling fluid 407 can undergo a phase change within the first tube 401. For example, the first cooling fluid 407 may comprise a liquid that may be injected into the first tube 401 from the coolant source 309. The first cooling fluid 407 may experience a pressure drop within the first tube 401, causing the first cooling fluid 407 to undergo a phase change from liquid to gas, such that a region within the first tube 401 may comprise a mixture of liquid particles and gas. As the pressure continues to lower along the first tube 401, the liquid may undergo a phase change to a solid.

In some embodiments, methods of manufacturing a glass ribbon can comprise cooling the first tube 401 by delivering the second cooling fluid 441 through the second tube 431 that surrounds the first tube 401 such that the second cooling fluid 441 is in convective contact with the first tube 401. For example, the second cooling fluid 441 can be delivered to the second tube 431 through the inlet 451. The second cooling fluid 441 can travel through the second channel 435 to an outlet 455, whereupon the second cooling fluid 441 can exit the second channel 435. In some embodiments, the second cooling fluid 441 can travel along the flow direction 601 in the same direction as the first cooling fluid 407 travels through the first tube 401. In some embodiments, the second cooling fluid 441 can travel opposite the flow direction 601 in an opposite direction that the first cooling fluid 407 travels through the first tube 401. In some embodiments, the second cooling fluid 441 can comprise a gas, for example, oxygen, nitrogen, etc. and/or a liquid, for example, liquid carbon dioxide, liquid nitrogen, etc. Due to the second channel 435 surrounding the first tube 401, the second cooling fluid 441 can surround the closed first sidewall 403.

In some embodiments, cooling the first tube 401 by delivering the second cooling fluid 441 through the second tube 431 can comprise thermally shielding the first tube 401 from a surrounding environment 603 by absorbing heat from the surrounding environment 603 with the second cooling fluid 441. By thermally shielding the first tube 401 from the surrounding environment 603, the second cooling fluid 441 can absorb heat from the surrounding environment 603, which can cause a first temperature increase of the second cooling fluid 441 and a second temperature increase of the first cooling fluid 407. However, due to the second cooling fluid 441 surrounding the first tube 401, the first temperature increase can be greater than the second temperature increase, such that the effects of the elevated temperature of the surrounding environment 603 on the first cooling fluid 407 may be lessened. For example, the first tube 401 can be thermally shielded from the surrounding environment 603 due to a path between the surrounding environment 603 and the first tube 401 passing through the second channel 435. In some embodiments, the surrounding environment 603 may be at an elevated temperature as compared to the first cooling fluid 407. Exposing the first cooling fluid 407 to the elevated temperature may cause a phase change of the first cooling fluid 407 from a solid or liquid particle to a gas within the first channel 405. As a result of this phase change, a reduced amount of the first cooling fluid 407 (e.g., in gas form) may reach the first end 411 of the first tube 401, thus limiting the cooling capacity of the first cooling fluid 407. The second cooling fluid 441 can therefore thermally shield the first tube 401 and, thus, the first cooling fluid 407, from the elevated temperature of the surrounding environment 603. For example, the second cooling fluid 441 may absorb a portion of the heat from the surrounding environment 603 as the second cooling fluid 441 flows through the second channel 435.

In some embodiments, the closed first sidewall 403 can isolate the first channel 405 from the second channel 435. For example, the closed first sidewall 403 may be free of openings, orifices, voids, vents, or the like, such that the first cooling fluid 407 may be prevented from passing through the closed first sidewall 403 from the first channel 405 to the second channel 435. Likewise, the second cooling fluid 441 may be prevented from passing through the closed first sidewall 403 from the second channel 435 to the first channel 405. As such, methods can comprise isolating the first cooling fluid 407 (e.g., by maintaining the first cooling fluid 407 within the first channel 405) from the second cooling fluid 441 (e.g., by maintaining the second cooling fluid 441 within the second channel 435) when the second cooling fluid 441 is delivered through the second tube 431 and when the first cooling fluid 407 is directed from the end (e.g., the second end 413) of the first tube 401.

In some embodiments, methods can comprise cooling the area 325 (e.g., of the ribbon of glass-forming material 103) by directing the first cooling fluid 407 from the second end 413 of the first tube 401 and through the nozzle 311 toward the area 325 of the ribbon of glass-forming material 103. For example, the first cooling fluid 407, which may comprise the one or more coolant particles 315 in one or more of a liquid phase, a solid phase, or a gas phase, may exit the outlet 419 of the first tube 401 at the second end 413 and may pass through the nozzle cavity 467 of the nozzle 311. In some embodiments, cooling the area 325 can comprise changing a phase of the first cooling fluid 407 while the first cooling fluid 407 is flowing toward the area 325 of the ribbon of glass-forming material 103. For example, the one or more coolant particles 315 that exit the nozzle 311 can travel along the flow direction 601 toward the travel path 221. In some embodiments, as the first cooling fluid 407 travels along the flow direction 601, a portion of the first cooling fluid 407 can undergo a phase change and may evaporate. For example, an ambient temperature between the nozzle 311 and the area 325 the ribbon of glass-forming material 103 may be high enough (e.g., within a range from about 400° C. to about 1000° C.) and greater than a boiling point of the coolant particles 315 to cause at least some of the one or more coolant particles 315 to evaporate by undergoing a phase change from a liquid phase or a solid phase to a gas phase, such that the one or more coolant particles 315 can be converted to the gas 322. In some embodiments, the phase change (e.g., to evaporate the one or more coolant particles 315 to form the gas 322) can occur after the first cooling fluid 407 has been discharged from the nozzle 311 but prior to the one or more coolant particles 315 reaching the ribbon of glass-forming material 103. However, in some embodiments, the ambient temperature may be higher than a boiling point of the first cooling fluid 407, such that the first cooling fluid 407 may be at risk of undergoing the phase change within the first tube 401 and prior to being discharged from the nozzle 311. For example, in some embodiments, the first cooling fluid 407 can comprise carbon dioxide, water, liquid nitrogen, etc.

In some embodiments, the portion of the first cooling fluid 407 that undergoes a phase change and evaporates prior to reaching the ribbon of glass-forming material 103 can comprise all of the first cooling fluid 407 such that none of the one or more coolant particles 315 reach the travel path 221 to contact the ribbon of glass-forming material 103. In some embodiments, the portion of the first cooling fluid 407 that undergoes a phase change and evaporates prior to reaching the ribbon of glass-forming material 103 can comprise some (e.g, less than all) of the first cooling fluid 407 such that some of the one or more coolant particles 315 reach the travel path 221 to contact the ribbon of glass-forming material 103. However, the amount of the one or more coolant particles 315 that contact the ribbon of glass-forming material 103 (e.g., and are not converted to the gas 322) can be small enough so as not to affect the quality of the ribbon of glass-forming material 103. Evaporation of the one or more coolant particles 315 into the gas 322 can yield several benefits. For example, when the one or more coolant particles 315 undergo a phase change and evaporate to form the gas 322, a reduction in air temperature can be achieved. For example, the air temperature adjacent to the ribbon of glass-forming material 103 can be reduced, which can cause the ribbon of glass-forming material 103 adjacent to the nozzle 311 to cool. Further, by forming the gas 322, some or none of the coolant particles 315 may contact the ribbon of glass-forming material 103, thus reducing the likelihood of an accumulation of material on a surface of the ribbon of glass-forming material 103.

In some embodiments, methods can comprise controlling a phase change of the first cooling fluid 407 within the first tube 401 by accelerating a flow of the first cooling fluid 407 within a first portion 619 of the first tube 401 prior to reaching the second end 413 (e.g, and prior to reaching the nozzle 311). For example, in some embodiments, by accelerating a flow of the first cooling fluid 407 within the first portion 619, an amount of time that the first cooling fluid 407 spends within the first portion 619 can be reduced as compared to embodiments in which the flow of the first cooling fluid 407 within the first portion 619 is not accelerated. In some embodiments, the first tube 401 can comprise the first portion 619 and a second portion 621. The second portion 621 can be located between the first end 411 of the first tube 401 and the first portion 619. The first portion 619 can be located between the second end 413 and the second portion 621. Therefore, a distance separating the second end 413 from the first portion 619 may be less than a distance separating the second end 413 from the second portion 621. The first cooling fluid 407 can comprise one or more coolant particles 623 flowing within the first channel 405. The one or more coolant particles 623 can comprise liquid particles, solid particles, and/or gas particles. In some embodiments, when the one or more coolant particles 623 undergo a phase change from a liquid particle to a gas particle, or from a solid particle to a gas particle, a change in density may occur, which can cause an acceleration of the one or more coolant particles 623.

In some embodiments, accelerating the flow of the first cooling fluid 407 within the first portion 619 of the first tube 401 can comprise enabling a phase change of a portion of the first cooling fluid 407 within the first portion 619 from one or more of the liquid phase or the solid phase to the gas phase. For example, in some embodiments, a temperature of the first portion 619 of the first tube 401 may be greater than a temperature of the second portion 621. This temperature variation may be due, in part, to a temperature near the ribbon of glass-forming material 103 being higher than a temperature near the first end 411 of the first tube 401. Due to the higher temperature near the ribbon of glass-forming material 103 (e.g., and, thus, near the second end 413), a portion of the one or more coolant particles 623 within the first portion 619 and closer to the second end 413 than the first end 411 can undergo the phase change (e.g., from the solid phase or liquid phase to the gas phase), thus causing an acceleration within the first portion 619. Enabling the phase change of the portion of the first cooling fluid 407 can be accomplished in several ways. For example, in some embodiments, a temperature of the second cooling fluid 441 entering the inlet 451 can be chosen such that a portion of the first cooling fluid 407 within the first portion 619 can undergo the phase change and, thus, the flow of the first cooling fluid 407 within the first portion 619 can be accelerated. In some embodiments, to enable the phase change, a thickness of the closed first sidewall 403 can differ at the first portion 619 from the second portion 621, such that a greater amount of the first cooling fluid 407 can undergo the phase change within the first portion 619. In further embodiments, to enable the phase change, the second tube 431 can comprise a differing thickness at the first portion 619 than at the second portion 621, such that differing cooling capacities of the first tube 401 can be achieved, thus allowing for the portion of the first cooling fluid 407 to undergo the phase change.

In some embodiments, methods can comprise extracting the first cooling fluid 407 by suction after the first cooling fluid 407 has been directed from the end of the first tube 401 and through the nozzle 311. For example, in some embodiments, the first cooling apparatus 303 can comprise a suction nozzle 651 positioned adjacent to the nozzle 311. The suction nozzle 651 can define an opening into which fluid can be drawn (e.g., illustrated with arrow 653) into the suction nozzle 651. In some embodiments, the suction nozzle 651 can remove air from the environment 603 near the area 325 and near the nozzle 311. By removing air, the suction nozzle 651 can reduce the pressure in the environment 603 near the nozzle 311, which can cause the gas 322 and the one or more coolant particles 315 to be drawn along a path (e.g., illustrated with arrow 653) into the suction nozzle 651. While one suction nozzle 651 is illustrated in FIG. 6, in some embodiments, a plurality of suction nozzles 651 may be provided in proximity to the nozzle 311. The suction nozzle 651 can provide several benefits. For example, due to the phase change of the first cooling fluid 407 upon exiting the nozzle 311, a density of the environment 603 can change. This density change can affect a pressure within the environment 603, which may have unwanted effects upon the ribbon of glass-forming material 103. To reduce any unwanted effects, the suction nozzle 651 can draw the gas 322 and the one or more coolant particles 315.

Referring to FIGS. 7-8, additional embodiments of a first cooling apparatus 701 are illustrated. The first cooling apparatus 701 illustrated in FIGS. 7-8 can be similar to the first cooling apparatus 303 illustrated in FIGS. 3-6. For example, referring to FIG. 7, the first cooling apparatus 701 can comprise the cooling tube 307 comprising the first tube 401 and the second tube 431 surrounded by the refractory material 461. In some embodiments, the first tube 401 can comprise a non-constant cross-sectional size between the first end 411 and the second end 413, wherein the non-constant cross-sectional size is measured between an inner surface of the first tube 401. For example, the first tube 401 can comprise a first cross-sectional size 703 at a first location 705 between the first end 411 and the second end 413, and a second cross-sectional size 707 at a second location 709 adjacent to the second end 413. In some embodiments, the cross-sectional size can comprise a maximum distance separating an inner surface of the first tube 401 along a direction that is perpendicular to the longitudinal axis 415. For example, when the first tube 401 comprises a circular cross-sectional shape, the first cross-sectional size 703 and the second cross-sectional size 707 can comprise a diameter (e.g., a linear distance) of the first tube 401. In some embodiments, the cross-sectional size can comprise an area of the first tube 401 along a plane perpendicular to the longitudinal axis 415.

The first location 705 can be located within the second portion 621 of the first tube 401 at a location between the first end 411 and the first portion 619. The second location 709 can be located within the first portion 619 of the first tube 401 at a location between the second end 413 and the second portion 621. In some embodiments, the first cross-sectional size 703 (e.g., at the first location 705) can be different than the second cross-sectional size 707 (e.g., at the second location 709), for example, wherein the first cross-sectional size 703 can be greater than the second cross-sectional size 707. For example, the first tube 401 can comprise a decreasing cross-sectional size, wherein a cross-sectional size of the first tube 401 at the first end 411 may be greater than the cross-sectional size of the first tube 401 at the second end 413. The non-constant cross-sectional size can be achieved in several ways. For example, in some embodiments, the closed second sidewall 433 can comprise a larger thickness at the first portion 619 than at the second portion 621, such that the first tube 401 can comprise the reduced second cross-sectional size 707 at the first portion 619.

Referring to FIG. 8, in some embodiments, methods of manufacturing a glass ribbon can comprise controlling a phase change of the first cooling fluid 407 within the first tube 401 by accelerating a flow of the first cooling fluid 407 within the first portion 619 of the first tube 401 prior to reaching the second end 413. For example, accelerating the flow of the first cooling fluid 407 can comprise reducing a cross-sectional size of the first portion 619 of the first tube 401 relative to the flow direction 601 of the first cooling fluid 407. The reduction in cross-sectional size may comprise a static reduction in the dimensions of the first tube 401 and not an active reduction, for example, wherein an active reduction may comprise applying a force to an outer surface of the first tube 401 to temporarily reduce the cross-sectional size of a portion of the first tube 401. Rather, the reduction in cross-sectional size can comprise a reduced dimension of the first tube 401 relative to the flow direction 601 from the first end 411 to the second end 413. In some embodiments, the first tube 401 may comprise the closed first sidewall 403 of a non-constant thickness, wherein at one location (e.g., the second portion 621), the closed first sidewall 403 can comprise a lesser thickness than at another location (e.g., the first portion 619). The differing thickness of the closed first sidewall 403 can achieve the reduction in cross-sectional size due to a narrowing of the first tube 401 from the second portion 621 to the first portion 619.

In addition, or in the alternative, in some embodiments, an auxiliary structure may be positioned within the first tube 401 at the first portion 619 to achieve the reduction in cross-sectional size. In some embodiments, due to the reduction in cross-sectional size, a flow rate of the one or more coolant particles 315 flowing through the first tube 401 can increase when flowing through the first portion 619 due to the second cross-sectional size 707 being greater than the first cross-sectional size 703. By accelerating the flow of the first cooling fluid 407 within the first portion 619, an amount of time that the first cooling fluid 407 spends within the first portion 619 can be reduced as compared to embodiments in which the flow of the first cooling fluid 407 within the first portion 619 is not accelerated. In some embodiments, a temperature of the first portion 619 of the first tube 401 may be greater than a temperature of the second portion 621. To reduce the likelihood of the first cooling fluid 407 undergoing a phase change within the first portion 619, the reduced cross-sectional size of the first portion 619 can facilitate a reduction in the amount of time that the first cooling fluid 407 spends within the first portion 619. As a result, a phase change of the first cooling fluid 407 within the first portion 619 may be limited, thus providing for a greater amount of coolant particles 315 passing through the nozzle 311 prior to converting to the gas 322.

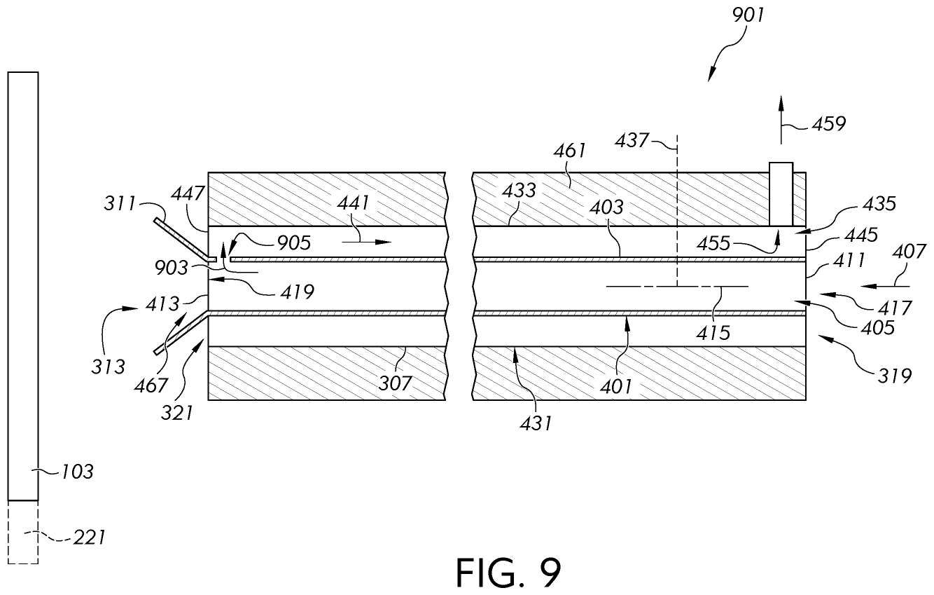

Referring to FIG. 9, additional embodiments of a first cooling apparatus 901 are illustrated. The first cooling apparatus 901 may be similar in some respects to the first cooling apparatus 301, 701 illustrated in FIGS. 3-8. However, in some embodiments, the first cooling apparatus 901 can comprise an opening 905 in the first tube 401 that can define a flow path 903 for the first cooling fluid 407. For example, adjacent to the second end 413 of the first tube 401, one or more openings (e.g., the opening 905) may be formed in the closed first sidewall 403. As such, a portion of the first cooling fluid 407 can exit the second end 413 and pas through the nozzle 311, while another portion of the first cooling fluid 407 can travel along the flow path 903 and through the opening 905. The opening 905 may be in fluid communication with the second channel 435. The first cooling fluid 407 can pass through the opening 905, whereupon the first cooling fluid 407 can function as the second cooling fluid 441 by cooling the first tube 401 and flowing toward the outlet 455. In some embodiments, a benefit of the first cooling apparatus 901 is that the inlet 451 (e.g., illustrated in FIGS. 5-8) may not be provided, such that a second, independent, cooling fluid may not be supplied to the second channel 435. Rather, the first cooling fluid 407 can function as the second cooling fluid 441 of FIGS. 5-8 by cooling the first tube 401.

The cooling tube 307 illustrated and described herein can yield several benefits. For example, by positioning the first tube 401 within the second tube 431, the first channel 405 of the first tube 401 can be maintained as a separate atmosphere from the second channel 435. For example, the first tube 401 may comprise the closed first sidewall 403 that is void of openings, while the second tube 431 may comprise the closed second sidewall 433 that is void of openings. As such, the first tube 401 can receive and transmit the first cooling fluid 407 while the second tube 431 can receive and transmit the second cooling fluid 441. The first cooling fluid 407 and the second cooling fluid 441 may not commingle or mix, such that the first cooling fluid 407 can be emitted from the first tube 401 toward the ribbon of glass-forming material 103 to cool the area 325, and the second cooling fluid 441 can contact the closed first sidewall 403 to cool the first tube 401. The second cooling fluid 441 can therefore cool the first tube 401 and thermally shield the first cooling fluid 407 from the elevated temperatures of the surrounding environment. By cooling the first tube 401, the likelihood of an unintended phase change of the first cooling fluid 407 while within the first channel 405 may be avoided. By limiting the unintended phase change of the first cooling fluid 407, the first cooling fluid 407 can be emitted from the first tube 401 in the form of the one or more coolant particles 315, which can undergo a phase change from solid or liquid to the gas 322 adjacent to the ribbon of glass-forming material 103, thus cooling the area 325.

In addition, in some embodiments, the cooling tube 307 can facilitate an acceleration of the flow of the first cooling fluid 407 at a location near the second end 413, for example, within the first portion 619 of the first tube 401. For example, at a location closer to the ribbon of glass-forming material 103, a temperature of the surrounding environment 603 may be higher as compared to a temperature near the first end 411. To reduce the amount of time the first cooling fluid 407 spends within the first portion 619, the first tube 401 can comprise a reduced cross-sectional size (e.g., the second cross-sectional size 707 at the second location 709) compared to the second portion 621 (e.g., the first cross-sectional size 703 at a first location 705). In some embodiments, to reduce the amount of time the first cooling fluid 407 spends within the first portion 619, a phase change of a portion of the first cooling fluid 407 can be enabled within the first portion 619. The phase change can result in a change in density, which can accelerate the first cooling fluid 407. In addition, the first tube 401 can comprise a cross-sectional size, for example, a diameter, that can facilitate a pressure drop between the first end 411 and the second end 413. For example, in some embodiments, the diameter of an interior of the first tube 401 can be within a range from about 0.25 mm to about 0.75 mm. When the pressure drop is too great, then a flow rate of the first cooling fluid 407 within the first tube 401 may be too low at the second end 413. For a smaller pressure drop, a desired flow rate of the first cooling fluid 407 can be maintained while limiting a phase change (e.g., liquid phase or solid phase to gas phase) within the first tube 401 at a certain temperature.

It should be understood that while various embodiments have been described in detail relative to certain illustrative and specific examples thereof, the present disclosure should not be considered limited to such, as numerous modifications and combinations of the disclosed features are possible without departing from the scope of the following claims.

1. A glass manufacturing apparatus comprising:
a forming apparatus defining a travel path extending in a travel direction, the forming apparatus configured to convey a ribbon of glass-forming material along the travel path in the travel direction; and
a cooling tube comprising a first end and a second end opposite the first end, the second end positioned adjacent to the travel path, the cooling tube comprising:
a first tube comprising a closed first sidewall surrounding a first channel, the first tube configured to receive a first cooling fluid within the first channel;
a second tube comprising a closed second sidewall surrounding a second channel, the first tube positioned within the second tube such that the second channel is between the closed first sidewall and the closed second sidewall, the second tube configured to receive a second cooling fluid within the second channel; and
a nozzle attached to the first tube, the nozzle comprising a nozzle cavity in fluid communication with the first channel, the nozzle configured to receive the first cooling fluid and direct the first cooling fluid toward the travel path.

2. The glass manufacturing apparatus of claim 1, wherein the first tube comprises a first cross-sectional size at a first location between the first end and the second end and a second cross-sectional size at a second location adjacent to the second end, wherein the first cross-sectional size is different than the second cross-sectional size.

3. The glass manufacturing apparatus of claim 2, wherein the first cross-sectional size is less than the second cross-sectional size.

4. The glass manufacturing apparatus of claim 1, wherein the first tube and the second tube are coaxial and extend along a longitudinal axis.

5. The glass manufacturing apparatus of claim 4, wherein an axis orthogonal to the longitudinal axis intersects the closed first sidewall and the closed second sidewall.

6. The glass manufacturing apparatus of claim 1, wherein the closed first sidewall isolates the first channel from the second channel.

7. A method of manufacturing a glass ribbon comprising:
forming a ribbon of glass-forming material;
moving the ribbon of glass-forming material along a travel path in a travel direction;
delivering a first cooling fluid through a first tube toward a nozzle;
cooling the first tube by delivering a second cooling fluid through a second tube that surrounds the first tube such that the second cooling fluid is in convective contact with the first tube to maintain a phase of the first cooling fluid within the first tube; and
cooling an area of the ribbon of glass-forming material by directing the first cooling fluid from an end of the first tube and through the nozzle toward the area of the ribbon of glass-forming material.

8. The method of claim 7, further comprising isolating the first cooling fluid from the second cooling fluid when the second cooling fluid is delivered through the second tube and when the first cooling fluid is directed from the end of the first tube.

9. The method of claim 8, wherein the cooling the first tube comprises thermally shielding the first tube from a surrounding environment by absorbing heat from the surrounding environment with the second cooling fluid.

10. The method of claim 7, further comprising controlling a phase change of the first cooling fluid within the first tube by accelerating a flow of the first cooling fluid within a first portion of the first tube prior to reaching the end of the first tube.

11. The method of claim 10, wherein the accelerating comprises reducing a cross-sectional size of the first portion of the first tube relative to a flow direction of the first cooling fluid.

12. The method of claim 10, wherein the accelerating comprises enabling a phase change of a portion of the first cooling fluid within the first portion from one or more of a liquid phase or a solid phase to a gas phase.

13. The method of claim 7, wherein the cooling the area comprises changing the phase of the first cooling fluid while the first cooling fluid is flowing toward the area of the ribbon of glass-forming material.

14. The method of claim 7, wherein the first cooling fluid comprises carbon dioxide.

15. A method of manufacturing a glass ribbon comprising:
forming a ribbon of glass-forming material;
moving the ribbon of glass-forming material along a travel path in a travel direction;
delivering a first cooling fluid through a first tube toward a nozzle;
controlling a phase change of the first cooling fluid within the first tube by accelerating a flow of the first cooling fluid within a first portion of the first tube prior to reaching the nozzle; and
cooling an area of the ribbon of glass-forming material by directing the first cooling fluid from an end of the first tube and through the nozzle toward the area of the ribbon of glass-forming material.

16. The method of claim 15, wherein the accelerating comprises reducing a cross-sectional size of the first portion of the first tube relative to a flow direction of the first cooling fluid.

17. The method of claim 15, wherein the accelerating comprises enabling a phase change of a portion of the first cooling fluid within the first portion from one or more of a liquid phase or a solid phase to a gas phase.

18. The method of claim 15, wherein the cooling the area comprises changing a phase of the first cooling fluid while the first cooling fluid is flowing toward the area.

19. The method of claim 15, wherein the first cooling fluid comprises carbon dioxide.

20. The method of claim 15, further comprising extracting the first cooling fluid by suction after the first cooling fluid has been directed from the end of the first tube and through the nozzle.
